(19) United States
(12) Patent Application Publication
(10) Pub. No.: US 2026/0332390 A1
(43) Pub. Date: Oct. 22, 2026

(54) SYSTEM AND METHOD FOR SECURE FILE TRANSFER

(71) Applicant: The Toronto-Dominion Bank, Toronto (CA)

(72) Inventors: Hongwei HONG, Markham (CA); Dragan VELICKOVIC, Richmond Hill (CA); Tony Yuhao YANG, Mississauga (CA)

(21) Appl. No.: 19/181,527

(22) Filed: Apr. 17, 2025

(51) Int. Cl. H04L 9/08; H04L 67/06

(52) U.S. Cl. CPC H04L 9/0825; H04L 9/0894; H04L 67/06

(57) ABSTRACT

Computing platforms, methods, and storage media for secure file transfer are disclosed. Exemplary implementations may: receive, e.g. via a microservice, a file transfer request to transfer a file from an on-premises server to cloud data storage; authenticate the microservice or an associated apparatus with the on-premises server using an external vault-stored authentication key which is stored independent of the on-premises server and the cloud data storage; and initiate the file transfer after authentication with the on-premises server. Authenticating with an external vault-stored authentication key, e.g. via a microservice, is more secure, allows a key to be easily updated should it change, and eliminates the need to take a virtual machine offline for such change. A database may be used to store configurations to allow a microservice to easily adapt to changes to a server and cloud data storage pair without having to directly change the code within the microservice.

### FIELD

The present disclosure relates to data communications, including but not limited to computing platforms, methods, and storage media for secure file transfer.

### BACKGROUND

The domain of enterprise information technology (IT) is dealing with an increased complexity of hosting environments, such as cloud and on-premises infrastructure. Regulatory processes can impose additional technical challenges, such as mandating certain types of processing of sensitive data stored on-premises and in the cloud. Consequently, the secure, timely, and efficient transfer of sensitive data from their on-premises location to a cloud storage is a priority for organizations to ensure security and data integrity.

Existing approaches include information exchange platforms, such as TIBCO® Managed File Transfer (MFT), to facilitate the secure transfer of files. However, these existing approaches do not have sufficiently secure, timely, and efficient approaches to transferring sensitive data to cloud storage (e.g. Azure™ Blob).

Improvements in approaches for secure file transfer are desirable.

### BRIEF DESCRIPTION OF THE DRAWINGS

Embodiments of the present disclosure will now be described, by way of example only, with reference to the attached Figures.

FIG. 1 illustrates a known system configured for secure file transfer.

FIG. 2 illustrates a system configured for secure file transfer, in accordance with one or more embodiments.

FIG. 3 illustrates a system configured for secure file transfer, in accordance with one or more embodiments.

FIG. 4 illustrates a method for secure file transfer, in accordance with one or more embodiments.

FIG. 5A and FIG. 5B illustrate block and flow diagrams of a system and method configured for secure file transfer, in accordance with one or more embodiments.

FIG. 6 illustrates a class diagram for a component of a system configured for secure file transfer, in accordance with one or more embodiments.

FIG. 7 illustrates a data model for a system configured for secure file transfer, in accordance with one or more embodiments.

### DETAILED DESCRIPTION

Computing platforms, methods, and storage media for secure file transfer are disclosed. Exemplary implementations may: receive, for example via a microservice, a file transfer request to transfer a file from an on-premises server to cloud data storage; authenticate the microservice or an associated apparatus with the on-premises server using an external vault-stored authentication key which is stored independent of the on-premises server and the cloud data storage; and initiate the file transfer after authentication with the on-premises server. Authenticating with an external vault-stored authentication key, for example via a microservice, is more secure, allows a key to be easily updated should it change, and eliminates the need to take a virtual machine offline for such change. In an implementation, the use of a database to store configurations allows a microservice to easily adapt to changes to a server and cloud data storage pair without having to directly change the code within the microservice.

The present disclosure provides a platform to perform, or enable performance, of a file transfer using an external key database rather than a virtual machine.

Embodiments of the present disclosure provide a system to transfer a file from an on-premises system to a cloud system, without being limited by current approaches such as a managed file transfer (MFT). According to a known approach, when using a key stored in a virtual machine, the VM must be taken offline to update the key. In accordance with one or more embodiments, key information is stored in an external vault, providing a more efficient and less costly approach to file transfer to the cloud.

There is a technical problem associated with known approaches in that authentication keys are stored in a virtual machine; changing an authentication key requires taking the virtual machine offline, as well as changing software code associated with the virtual machine. In accordance with one or more embodiments, a technical solution is provided by storing authentication keys, and information associated with authentication keys, in an external vault, for outside of a microservice being used to enable a file transfer. The authentication keys may be stored in a key vault, and information associated with the authentication keys may be stored in a configuration database. This allows changes to be made to the authentication keys, without having to take a microservice or virtual machine offline.

One aspect of the present disclosure relates to a computing platform configured for secure file transfer. The computing platform may include a non-transient computer-readable storage medium having executable instructions embodied thereon. The computing platform may include one or more hardware processors configured to execute the instructions. The processor(s) may execute the instructions to receive, such as via a microservice, a file transfer request to transfer a file from an on-premises server to cloud data storage. The processor(s) may execute the instructions to authenticate the microservice or an associated apparatus with the on-premises server using an external vault-stored authentication key which is stored independent of the on-premises server and the cloud data storage. The processor(s) may execute the instructions to initiate the file transfer after authentication with the on-premises server.

Another aspect of the present disclosure relates to a method for secure file transfer. The method may include receiving, for example via a microservice, a file transfer request to transfer a file from an on-premises server to cloud data storage. The method may include authenticating the microservice or an associated apparatus with the on-premises server using an external vault-stored authentication key which is stored independent of the on-premises server and the cloud data storage. The method may include initiating the file transfer after authentication with the on-premises server.

Yet another aspect of the present disclosure relates to a non-transient computer-readable storage medium having instructions embodied thereon, the instructions being executable by one or more processors to perform a method for secure file transfer. The method may include receiving, for example via a microservice, a file transfer request to transfer a file from an on-premises server to cloud data storage. The method may include authenticating the microservice or an associated apparatus with the on-premises server using an external vault-stored authentication key, which is stored independent of the on-premises server and the cloud data storage. The method may include initiating the file transfer after authentication with the on-premises server.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

A virtual machine (VM) is a software-based emulation or virtualization of a computer system, which uses software instead of a physical computer to run programs or deploy apps. A VM is typically isolated from underlying physical hardware, operating as if it were a standalone system. A plurality of different virtual machines can run on the same physical computing device, with each of the plurality of VMs operating separately. One known example is a MacOS virtual machine that can run on a Windows computer. A VM can run its own operating system and applications. A VM can be provided at an application level, or at a machine or system level.

A microservice is a modular service, where each microservice can be deployed independently, and can be implemented separately. An application can be structured as a collection of small, independent microservices, rather than a singular application. This enables the introduction and release of new features quickly, as separate microservices, and with less risk. Changes to one microservice do not affect other microservices in the same application. Microservices may be used on cloud applications and in serverless computing. Some examples of microservices in the e-commerce field include a product catalog microservice, a shopping cart microservice, and a payment processing microservice. A microservice may be run or deployed in a virtual machine, and different microservices may have their own VM. A microservice may also be deployed in a container, where a container does not need or use its own operating system. A container is typically more lightweight and includes only an application and the required minimum system libraries, in contrast to a VM that includes an entire operating system.

In computing, a mount or mounting refers to a process of making files and directories on a storage device accessible to a computing device or user, for example via an operating system through a system's directory tree. This may include associating a storage device to a particular location in a directory tree, for example a logical D: drive. Mounting may be equated to providing a logically defined place to be accessed. Mounting a drive may involve an operating system acquiring access to a storage medium, which may include obtaining information on a file system structure and related metadata. Mounting a cloud storage service makes a local operating system think it sees a normal local file system, when the files are really in the cloud. Directly accessing cloud data storage without mounting the cloud data storage to a file transfer process provides an advantage of reduced resource and processor usage.

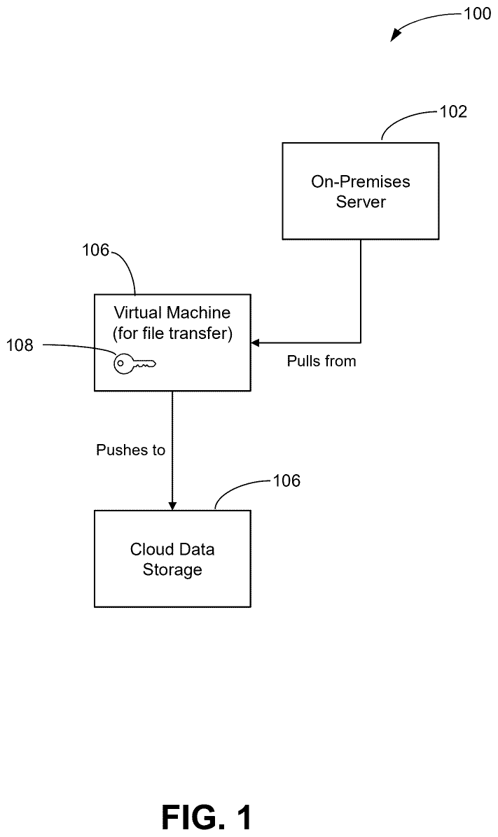

FIG. 1 illustrates a known system 100 configured for secure file transfer. Currently, a widely accepted approach to transferring a file between an on-premises server 102 to a cloud data storage 104 is through a virtual machine 106, for example with an executable shell script. The server 102 may comprise a TIBCO server from TIBCO Software Inc.

The shell script may access the server 102 using Secure Shell Protocol (SSH). To do this, the virtual machine 106 will also need to authenticate with the server 102 using an authentication key 108, which is stored in the virtual machine. The shell script accesses the cloud data storage 104 by using a respective cloud storage mount library (e.g. Azure Blob Fuse). The shell script act as a sort of middle-man: downloading the file from one location to its own memory before then uploading that file from its own memory to the other location.

Such a known solution as shown in FIG. 1 may suffer from one or more of the following drawbacks:

An organization's policy may require that the keys 108 needed to authenticate with the server 102 be changed intermittently. When this occurs, the keys must be changed in the virtual machine 106. Otherwise, the entire flow is halted, leading to downtime.

To change the keys 108 in a virtual machine 106, the virtual machine 106 must be restarted. This brings down the virtual machine 106 leading to further downtime.

Storing the authentication keys 108 in the virtual machine 106 is highly insecure as anyone with the ability to access the virtual machine 106 can access the keys 108. This compromises the security of the server 102.

A shell script is limited in what it can do. This limits to how this known solution can handle errors, log actions, or perform encryption. The use of a shell script leads to rigid maintenance. If either the server 102 or the cloud data storage 104 changes, the script would have to be rewritten to accommodate. This would require restarting the virtual machine 106, leading to further downtime.

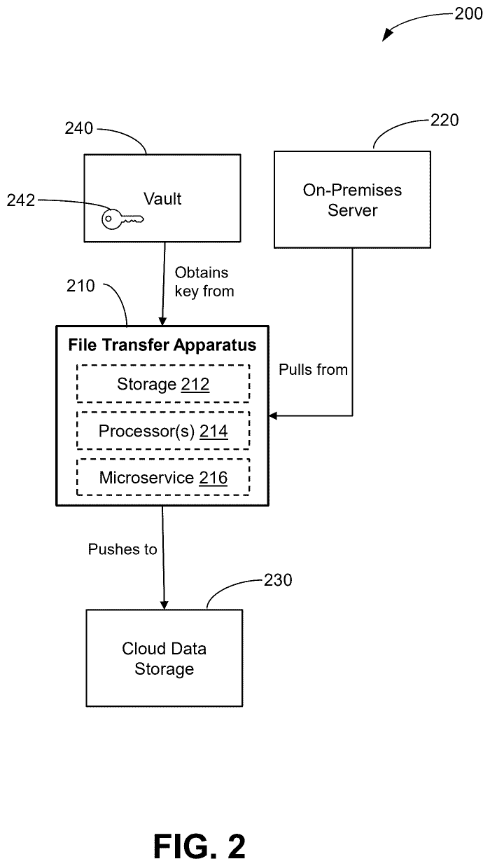

FIG. 2 illustrates a system 200 configured for secure file transfer, in accordance with one or more embodiments. A file transfer apparatus 210 is in communication with an on-premises server 220 and with a cloud data storage 230. An external vault 240 may be in communication with the file transfer apparatus 210. The external vault 240 may comprise a key vault, which may be configured to securely store and manage sensitive information such as keys, passwords, secrets and certificates, and may be provided as a cloud-based service.

The file transfer apparatus 210 may comprise one or more non-transient computer-readable storage media 212 having executable instructions embodied thereon, and one or more hardware processors 214. The file transfer apparatus 210 may comprise or be configured to run a microservice 216. In another embodiment, the microservice 216 is run or hosted on any virtual or physical machine, not necessarily on the file transfer apparatus 210.The one or more hardware processors 214 may be configured to execute the instructions to receive, for example via the microservice 216, a file transfer request to transfer a file from the on-premises server 220 to cloud data storage 230. The one or more hardware processors 214 may be configured to execute the instructions to authenticate the microservice 216 or the apparatus 210 with the on-premises server 220 using an external vault-stored authentication key 242, which is stored independent of the on-premises server 220 and the cloud data storage 230, for example stored in the vault 240. The one or more hardware processors 214 may be configured to execute the instructions to initiate the file transfer after authentication with the on-premises server 220.

In an embodiment, file transfer apparatus 210 is configured to run the microservice 216. The one or more hardware processors 214 may be configured to receive, via the microservice 216, the file transfer request, and to authenticate with the on-premises server 220 using the external vault-stored authentication key 242 stored in the key vault 240 and independent of the microservice 216.

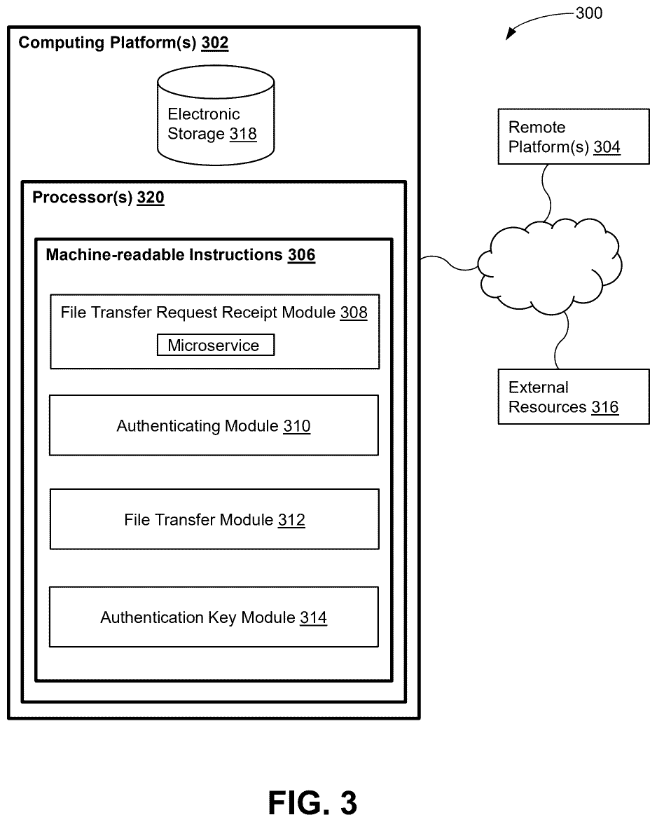

FIG. 3 illustrates a system 300 configured for secure file transfer, in accordance with one or more embodiments. In some embodiments, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of file transfer request receipt module 308, authenticating module 310, file transfer module 312, authentication key module 314, and/or other instruction modules.

File transfer request receipt module 308 may be configured to receive a file transfer request to transfer a file from an on-premises server to cloud data storage. File transfer request receipt module 308 may be configured to receive, via a microservice, the file transfer request. File transfer request receipt module 308 may comprise a microservice.

Authenticating module 310 may be configured to authenticate a microservice or an associated apparatus with the on-premises server using an external vault-stored authentication key which is stored independent of the on-premises server and the cloud data storage.

Authenticating module 310 may be configured to authenticate a microservice or an associated apparatus with the on-premises server using the external vault-stored authentication key stored in the key vault and independent of the microservice. Authenticating module 310 may be configured to authenticate a microservice or an associated apparatus with the on-premises server using the external vault-stored authentication key stored in a vault in the database and using key management data stored in a system performing the authenticating. Authenticating module 310 may be configured to authenticate a microservice or an associated apparatus with the on-premises server using the external vault-stored authentication key stored in a vault in the database and using transfer destination data, such as source-to-target mapping, stored in a system performing the authenticating.

File transfer module 312 may be configured to initiate the file transfer after authentication, for example authentication of the microservice or an associated apparatus, with the on-premises server. File transfer module 312 may be configured to directly transfer the file without downloading the file to local memory. File transfer module 312 may be configured to perform the file transfer using the microservice and authenticate the microservice with the on-premises server. File transfer module 312 may be configured to directly access the cloud data storage without mounting the cloud data storage to a file transfer process.

Authentication key module 314 may be configured to update an authentication key in a configuration database without code modification in a system performing the authenticating. Authentication key module 314 may be configured to provide a user interface to enable authentication key reconfiguration in a database.

In some embodiments, computing platform(s) 302, remote platform(s) 304, and/or external resources 316 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 316 may be operatively linked via some other communication media.

A given remote platform 304 may include one or more processors configured to execute computer program modules. The computer program modules may be configured to enable an expert or user associated with the given remote platform 304 to interface with system 300 and/or external resources 316, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 316 may include sources of information outside of system 300, external entities participating with system 300, and/or other resources. In some embodiments, some or all of the functionality attributed herein to external resources 316 may be provided by resources included in system 300.

Computing platform(s) 302 may include electronic storage 318, one or more processors 320, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302. Electronic storage 318 may comprise non-transitory storage media that electronically stores information. The electronic storage media of electronic storage 318 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 318 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 318 may include one or more virtual storage resources (e.g., cloud storage, a virtual private network, and/or other virtual storage resources). Electronic storage 318 may store software algorithms, information determined by processor(s) 320, information received from computing platform(s) 302, information received from remote platform(s) 304, and/or other information that enables computing platform(s) 302 to function as described herein.

Processor(s) 320 may be configured to provide information processing capabilities in computing platform(s) 302. As such, processor(s) 320 may include one or more of a digital processor, an analog processor, a digital circuit designed to process information, an analog circuit designed to process information, a state machine, and/or other mechanisms for electronically processing information. Although processor(s) 320 is shown in FIG. 3 as a single entity, this is for illustrative purposes only. In some embodiments, processor(s) 320 may include a plurality of processing units. These processing units may be physically located within the same device, or processor(s) 320 may represent processing functionality of a plurality of devices operating in coordination. Processor(s) 320 may be configured to execute modules 308, 310, 312, 314 and/or 316, and/or other modules. Processor(s) 320 may be configured to execute modules 308, 310, 312 and/or 314, and/or other modules by software; hardware; firmware; some combination of software, hardware, and/or firmware; and/or other mechanisms for configuring processing capabilities on processor(s) 320. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, are illustrated in FIG. 3 as being implemented within a single processing unit, in embodiments in which processor(s) 320 includes multiple processing units, one or more of modules 308, 310, 312 and/or 314 may be implemented remotely from the other modules. The description of the functionality provided by the different modules 308, 310, 312312 and/or 314 described below is for illustrative purposes, and is not intended to be limiting, as any of modules 308, 310, 312 and/or 314 may provide more or less functionality than is described. For example, one or more of modules 308, 310, 312 and/or 314 may be eliminated, and some or all of its functionality may be provided by other ones of modules 308, 310, 312 and/or 314. As another example, processor(s) 320 may be configured to execute one or more additional modules that may perform some or all of the functionality attributed below to one of modules 308, 310, 312 and/or 314.

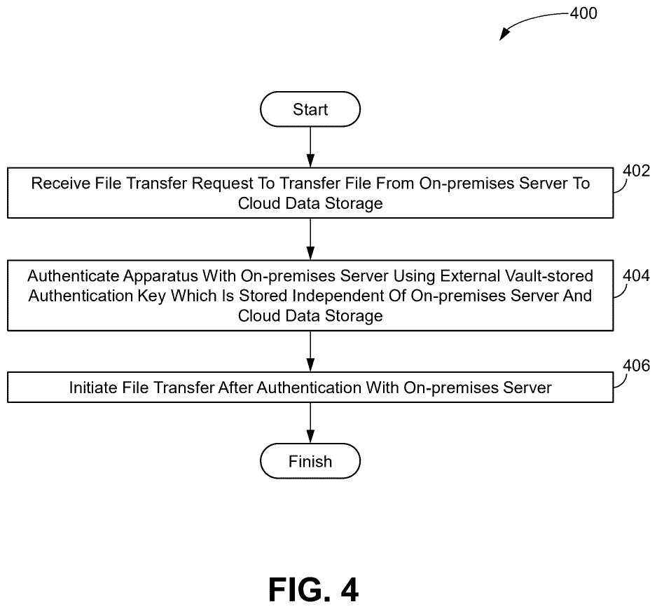

FIG. 4 illustrates a method 400 for secure file transfer, in accordance with one or more embodiments. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include receiving, for example via a microservice, a file transfer request to transfer a file from an on-premises server to cloud data storage. Operation 402 may be performed by one or more hardware processors configured by machine-readable instructions including a module that is the same as or similar to file transfer request receipt module 308, in accordance with one or more embodiments.

An operation 404 may include authenticating a microservice or an associated apparatus with the on-premises server using an external vault-stored authentication key which is stored independent of the on-premises server and the cloud data storage. Operation 404 may be performed by one or more hardware processors configured by machine-readable instructions including a module that is the same as or similar to authenticating module 310, in accordance with one or more embodiments.

An operation 406 may include initiating the file transfer after authentication with the on-premises server. Operation 406 may be performed by one or more hardware processors configured by machine-readable instructions including a module that is the same as or similar to file transfer module 312, in accordance with one or more embodiments.

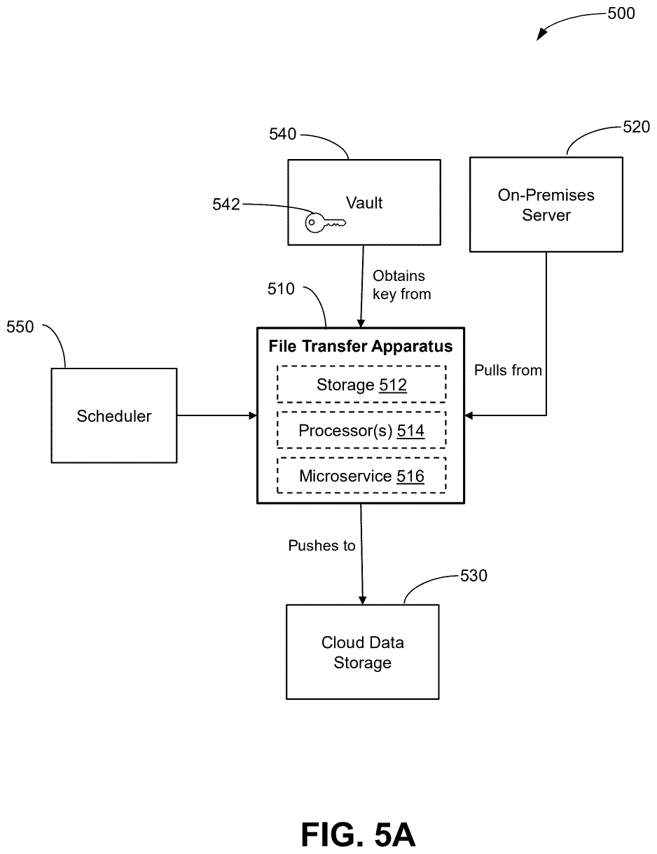

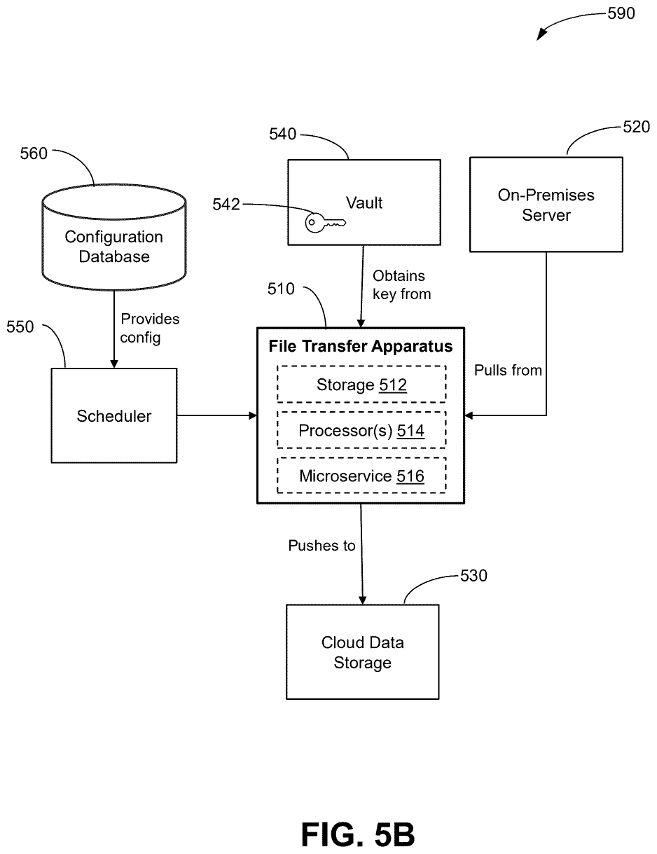

FIG. 5A and FIG. 5B illustrate block and flow diagrams of a system and method configured for secure file transfer, in accordance with one or more embodiments. FIG. 5A illustrates a system 500 configured for secure file transfer, in accordance with one or more embodiments. A file transfer apparatus 510 is in communication with an on-premises server 520 and with a cloud data storage 530. The cloud data storage 530 may be, for example, Azure Blob storage. An external vault 540 may be in communication with the file transfer apparatus 510. The external vault 540 may comprise a key vault.

The file transfer apparatus 510 may comprise a non-transient computer-readable storage medium 512 having executable instructions embodied thereon, and one or more hardware processors 514. The file transfer apparatus 510 may comprise or be configured to run a microservice 516. In another embodiment, the microservice 516 is run or hosted on any virtual or physical machine, not necessarily on the file transfer apparatus 510. The one or more hardware processors 514 may be configured to execute the instructions to receive, for example via the microservice 516, a file transfer request to transfer a file from the on-premises server 520 to cloud data storage 530. The one or more hardware processors 514 may be configured to execute the instructions to authenticate the microservice 516 or the associated apparatus, such as 510, with the on-premises server 520 using an external vault-stored authentication key 542, which is stored independent of the on-premises server 520 and the cloud data storage 530, for example stored in the vault 540. The one or more hardware processors 514 may be configured to execute the instructions to initiate the file transfer after authentication with the on-premises server 520.

The solution in FIG. 5A and FIG. 5B may utilize a Java Microservice 516, instead of a virtual machine used in known approaches, to perform the transfer between the on-premises server 520 and the cloud data storage 530. The microservice 516 may be configured to access the server 520 using Secure Shell Protocol, leveraging a greater array of libraries to achieve this than known virtual machine approaches. Unlike the virtual machine, the microservice 516 may directly access the cloud data storage 530 without having to mount the storage to its process. Once connected to the server 520 and the cloud data storage 530, the microservice 516 may directly transfer the file from the server 520 to the storage 530 without needing to download the file on to its own memory. This results in both resource and cost savings, and improves the functioning of the computer or apparatus on which the microservice is running.

The microservice 516 may cooperate with the on-premises server 520 and the cloud data storage 530 to improve functioning of the processor(s) 514 executing or associated with execution of the microservice 516, by making the processor(s) 514 more efficient. For example, the microservice 516 may enable authentication of the microservice or associated apparatus with a key stored in an external vault, allowing the key(s) to be updated without service interruption. This is an improvement over known virtual machine approaches where the key(s) are stored in the virtual machine. This improvement reduces the processor load and cost, as well as reducing the memory required, and increases the availability and uptime of the processor(s) 514 and the storage 512. Such improvements and solutions to computer problems are also achieved by methods of one or more embodiments described and illustrated herein.

By moving the authentication keys 542 to the external vault 540, which may be implemented as a Hashicorp Vault, the microservice 516 may access the keys 542 needed to authenticate with an on-premises server 520 without needing to store them within its own configuration files.

As shown in FIG. 5A, a scheduler 550 may be provided in communication with the file transfer apparatus 510. The scheduler 550 may be configured to store scheduling data. The scheduling data may be used to configure the microservice 516 to run on a schedule to perform a file transfer at any designated time. The scheduler 550 may be configured to run on a defined schedule, such as every X minutes.

FIG. 5B illustrates a system 590 configured for secure file transfer, in accordance with one or more embodiments. The file transfer apparatus 512, the microservice 516, the on-premises server 520, the cloud data storage 530, the vault 540 and the scheduler 550, and their interactions, have all been described in relation to FIG. 5A, and their detailed description is relevant to and also applicable to FIG. 5B in view the similarity of the embodiments.

As shown in FIG. 5B, a configuration database 560 may be provided in communication with the scheduler 550. The configuration database 560 may be configured to store relevant configuration information that the microservice 516 needs in order to perform a file transfer job. Relevant configuration information may include, for example, job schedules, key names, server credentials, etc.

A solution according to embodiments of the present disclosure, for example as described thus far in relation to FIGS. 2-5B, offers several solutions to the issues with known approaches. In accordance with one or more embodiments, the keys are stored separately from the microservice within an external vault, allowing the keys to be easily updated should they change. In accordance with one or more embodiments, the keys are stored separately from microservice within an external vault, eliminating the need to redeploy when the keys change. An external vault, such as a Hashicorp Vault, is a more secure industry-standard key storage solution than directly storing the keys in a virtual machine according to known approaches. A microservice, such as a Java microservice, provides an advantage in that Java has advanced library support, allowing a Java-based microservice to leverage better error handling, error logging, and encryption security. The use of a configuration database to store file transfer configurations allows the microservice to easily adapt to changes to the server/cloud data storage without having to directly change the code within microservice.

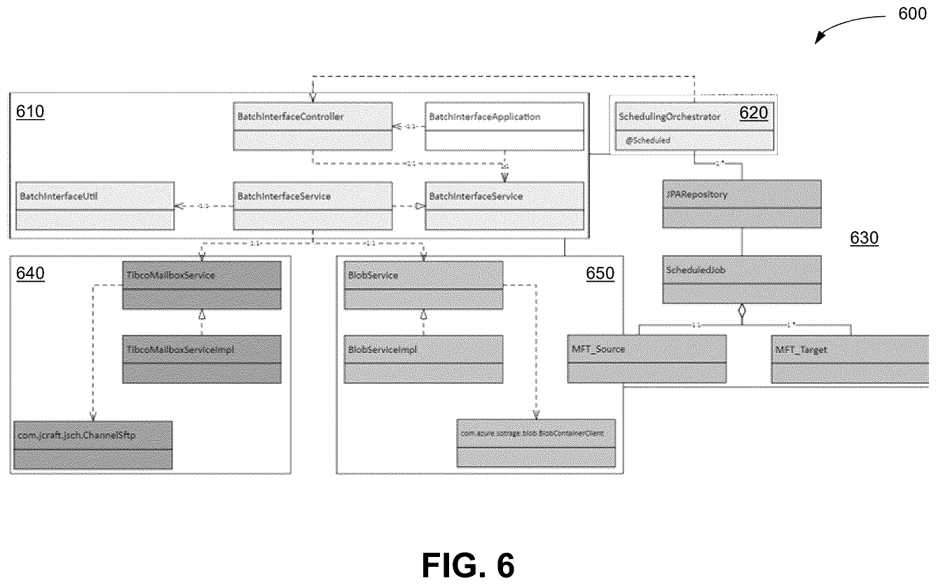

FIG. 6 illustrates a class diagram 600 for a component of a system configured for secure file transfer, in accordance with one or more embodiments. The class diagram in FIG. 6 may be for a file transfer apparatus 510, such as shown in FIG. 5A and FIG. 5B, or for a microservice 516 such as shown in FIG. 5A and FIG. 5B. A set of file transfer control components 610 may be configured to control the file transfer between an on-premise server and a cloud data storage. A scheduling orchestrator component 620 may be configured to schedule all of the transfers. A set of database access components 630 may be configured to access the database containing all of the configurations. A set of server access configuration components 640 may be configured to access the server via SSH. A set of cloud data storage access components 650 may be configured to access the Azure Blob, or other cloud data storage.

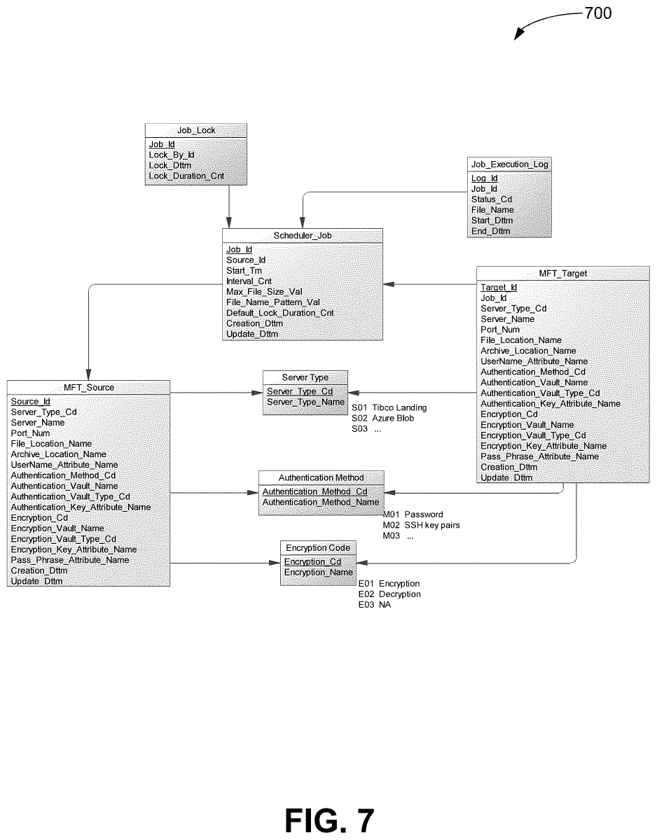

FIG. 7 illustrates a data model 700 for a system configured for secure file transfer, in accordance with one or more embodiments. Embodiments of the present disclosure may be configured to take all of the source, target, interval and key name configurations and store them in a database, for example such as configuration database 560 in FIG. 5B. The example embodiment of FIG. 7 illustrates “MFT_Source” and “MFT_Target” components, each with various data values or data components relating to a source and a target of a file transfer, such as server type and name, file location name, and authentication and encryption data. A scheduler, such as scheduler 550 in FIG. 5B, may be modified to read from a database to schedule a managed file transfer for different jobs. The example embodiment of FIG. 7 illustrates “Scheduler_Job” component, with various data values or data components relating to job scheduling, such as start time and interval. At a lower level, a system according to one or more embodiments may be configured to remove an “application. properties” file, as well as a scheduled component. A system in accordance with one or more embodiments may comprise a scheduling orchestrator, such as scheduling orchestrator component 620 in FIG. 6, which may be configured to dynamically schedule jobs to perform a file transfer at desired times or at required times.

A database using a data model as shown in FIG. 7 may be configured to specify source, start time of job, interval between current job and next, file name pattern, job lock duration, among others. A source and target table as shown in FIG. 7 may specify configuration information (name of server, port number, file location, archive location, username) to authenticate to access server, authentication method code and other material.

A solution according to one or more embodiments may offer one or more of the following technical benefits. In accordance with one or more embodiments, a virtual machine used in known approaches is replaced with a much cheaper Java microservice, which reduces cloud costs. In accordance with one or more embodiments, the simplified key management in an external vault removes the need for an operational process to refresh the keys, reducing the maintenance costs of the transfer process. In accordance with one or more embodiments, the use of a configuration database to store transfer destination information allows additional transfer destinations to be added in the future. In accordance with one or more embodiments, a microservice may be configured to grow beyond just transfers between servers and cloud data storage. In accordance with one or more embodiments, a microservice may be configured to grow to accommodate for transfers between a single source to multiple destinations. In accordance with one or more embodiments, the use of a configuration database to store authentication information allows future authentication methods to be added in the future, which allows a microservice to accommodate for future authentication methods that may arise.

Embodiments of the present disclosure may be configured to replace a current process of file transfer with a microservice, externalizing key configurations to a vault and database. A known process of pulling files from a mailbox and sending them to Azure Blob may be replaced with a microservice. Keys for accessing the vault may be stored separately, allowing for easier updates without impacting the microservice. Embodiments may support pulling from different sources and pushing to different destinations, requiring changes in access keys, scheduler, and encryption. Known approaches involve storing keys within a VM, requiring the VM to be stopped and restarted when the keys are refreshed. Embodiments of the present disclosure may be configured to externalize key configurations to a vault and storing key information in a database, eliminating the need for VM restarts. A database-driven approach of embodiments of the present disclosure allows for easy addition of new transfers without modifying the code, reducing complexity and enabling scalability.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a processor-implemented method for secure file transfer. The method may include receiving, for example via a microservice, a file transfer request to transfer a file from an on-premises server to cloud data storage. The method may include authenticating an apparatus or the microservice with the on-premises server using an external vault-stored authentication key which is stored independent of the on-premises server and the cloud data storage. The method may include initiating the file transfer after authentication with the on-premises server.

In some implementations of the system, the processor(s) may be configured to receive, via a microservice, the file transfer request. In some implementations of the system, the processor(s) may be configured to authenticate with the on-premises server using the external vault-stored authentication key stored in the key vault and independent of the microservice.

In some implementations of the system, the processor(s) may be configured to authenticate with the on-premises server using the external vault-stored authentication key stored in a vault in the database and using key management data stored in a system performing the authenticating.

In some implementations of the system, the processor(s) may be configured to authenticate with the on-premises server using the external vault-stored authentication key stored in a vault in the database and using transfer destination data (source-to-target mapping) stored in a system performing the authenticating.

In some implementations of the system, the processor(s) may be configured to update an authentication key in a configuration database without code modification in a system performing the authenticating.

In some implementations of the system, the processor(s) may be configured to provide a user interface to enable authentication key reconfiguration in a database.

In some implementations of the system, the processor(s) may be configured to directly access the cloud data storage without mounting the cloud data storage to a file transfer process.

In some implementations of the system, the processor(s) may be configured to: obtain, from a scheduler, file transfer scheduling data; and automatically initiate the file transfer based on the file transfer scheduling data.

In some implementations of the system, the processor(s) may be configured to directly transfer the file without downloading the file to local memory.

In some implementations of the system, the processor(s) may be configured to: obtain, from a configuration database, file transfer configuration data; and initiate the file transfer based on the file transfer configuration data.

Another aspect of the present disclosure relates to a processor-implemented method for secure file transfer. The method may include receiving, for example via a microservice, a file transfer request to transfer a file from an on-premises server to cloud data storage. The method may include authenticating an apparatus or the microservice with the on-premises server using an external vault-stored authentication key which is stored independent of the on-premises server and the cloud data storage. The method may include initiating the file transfer after authentication with the on-premises server.

Some implementations of the method may include receiving, via a microservice, the file transfer request. Some implementations of the method may include authenticating with the on-premises server using the external vault-stored authentication key stored in the key vault and independent of the microservice.

Some implementations of the method may include authenticating with the on-premises server using the external vault-stored authentication key stored in a vault in the database and using key management data stored in a system performing the authenticating.

Some implementations of the method may include authenticating with the on-premises server using the external vault-stored authentication key stored in a vault in the database and using transfer destination data (source-to-target mapping) stored in a system performing the authenticating.

Some implementations of the method may include updating an authentication key in a configuration database without code modification in a system performing the authenticating.

Some implementations of the method may include providing a user interface to enable authentication key reconfiguration in a database.

Some implementations of the method may include directly accessing the cloud data storage without mounting the cloud data storage to a file transfer process.

Some implementations of the method may include: obtaining, from a scheduler, file transfer scheduling data; and automatically initiating the file transfer based on the file transfer scheduling data.

Some implementations of the method may include directly transferring the file without downloading the file to local memory.

Some implementations of the method may include: obtaining, from a configuration database, file transfer configuration data; and initiating the file transfer based on the file transfer configuration data.

Yet another aspect of the present disclosure relates to a non-transient computer-readable storage medium having instructions embodied thereon, the instructions being executable by one or more processors to perform a method for secure file transfer. The method may include receiving a file transfer request to transfer a file from an on-premises server to cloud data storage. The method may include authenticating the apparatus with the on-premises server using an external vault-stored authentication key which is stored independent of the on-premises server and the cloud data storage. The method may include initiating the file transfer after authentication with the on-premises server.

In some implementations of the computer-readable storage medium, the method may include receiving, via a microservice, the file transfer request. In some implementations of the computer-readable storage medium, the method may include authenticating with the on-premises server using the external vault-stored authentication key stored in the key vault and independent of the microservice.

In some implementations of the computer-readable storage medium, the method may include authenticating with the on-premises server using the external vault-stored authentication key stored in a vault in the database and using key management data stored in a system performing the authenticating. In some implementations of the computer-readable storage medium, the method may include authenticating with the on-premises server using the external vault-stored authentication key stored in a vault in the database and using transfer destination data (source-to-target mapping) stored in a system performing the authenticating.

In some implementations of the computer-readable storage medium, the method may include updating an authentication key in a configuration database without code modification in a system performing the authenticating. In some implementations of the computer-readable storage medium, the method may include providing a user interface to enable authentication key reconfiguration in a database.

In some implementations of the computer-readable storage medium, the method may include directly accessing the cloud data storage without mounting the cloud data storage to a file transfer process. In some implementations of the computer-readable storage medium, the method may include directly transferring the file without downloading the file to local memory.

In some implementations of the computer-readable storage medium, the method may include: obtaining, from a scheduler, file transfer scheduling data; and automatically initiating the file transfer based on the file transfer scheduling data.

In some implementations of the computer-readable storage medium, the method may include obtaining, from a configuration database, file transfer configuration data; and initiating the file transfer based on the file transfer configuration data.

Still another aspect of the present disclosure relates to a system configured for secure file transfer. The system may include means for receiving a file transfer request to transfer a file from an on-premises server to cloud data storage. The system may include means for authenticating the apparatus with the on-premises server using an external vault-stored authentication key which is stored independent of the on-premises server and the cloud data storage. The system may include means for initiating the file transfer after authentication with the on-premises server.

In some implementations of the system, the system may include means for receiving, via a microservice, the file transfer request. In some implementations of the system, the system may include means for authenticating with the on-premises server using the external vault-stored authentication key stored in the key vault and independent of the microservice.

In some implementations of the system, the system may include means for authenticating with the on-premises server using the external vault-stored authentication key stored in a vault in the database and using key management data stored in a system performing the authenticating.

In some implementations of the system, the system may include means for authenticating with the on-premises server using the external vault-stored authentication key stored in a vault in the database and using transfer destination data (source-to-target mapping) stored in a system performing the authenticating.

In some implementations of the system, the system may include means for updating an authentication key in a configuration database without code modification in a system performing the authenticating.

In some implementations of the system, the system may include means for providing a user interface to enable authentication key reconfiguration in a database.

In some implementations of the system, the system may include means for directly accessing the cloud data storage without mounting the cloud data storage to a file transfer process.

In some implementations of the system, the system may include means for: obtaining, from a scheduler, file transfer scheduling data; and automatically initiating the file transfer based on the file transfer scheduling data.

In some implementations of the system, the system may include means for directly transferring the file without downloading the file to local memory.

In some implementations of the system, the system may include means for obtaining, from a configuration database, file transfer configuration data. In some implementations of the system, the system may include means for obtaining, from a configuration database, file transfer configuration data; and initiating the file transfer based on the file transfer configuration data.

Even another aspect of the present disclosure relates to a computing platform configured for secure file transfer. The computing platform may include a non-transient computer-readable storage medium having executable instructions embodied thereon. The computing platform may include one or more hardware processors configured to execute the instructions. The processor(s) may execute the instructions to receive, for example via a microservice, a file transfer request to transfer a file from an on-premises server to cloud data storage. The processor(s) may execute the instructions to authenticate the apparatus with the on-premises server using an external vault-stored authentication key which is stored independent of the on-premises server and the cloud data storage. The processor(s) may execute the instructions to initiate the file transfer after authentication with the on-premises server.

In some implementations of the computing platform, the processor(s) may execute the instructions to receive, via a microservice, the file transfer request. In some implementations of the computing platform, the processor(s) may execute the instructions to authenticate with the on-premises server using the external vault-stored authentication key stored in the key vault and independent of the microservice.

In some implementations of the computing platform, the processor(s) may execute the instructions to authenticate with the on-premises server using the external vault-stored authentication key stored in a vault in the database and using key management data stored in a system performing the authenticating.

In some implementations of the computing platform, the processor(s) may execute the instructions to authenticate with the on-premises server using the external vault-stored authentication key stored in a vault in the database and using transfer destination data (source-to-target mapping) stored in a system performing the authenticating.

In some implementations of the computing platform, the processor(s) may execute the instructions to update an authentication key in a configuration database without code modification in a system performing the authenticating.

In some implementations of the computing platform, the processor(s) may execute the instructions to provide a user interface to enable authentication key reconfiguration in a database.

In some implementations of the computing platform, the processor(s) may execute the instructions to directly access the cloud data storage without mounting the cloud data storage to a file transfer process.

In some implementations of the computing platform, the processor(s) may execute the instructions to: obtain, from a scheduler, file transfer scheduling data; and automatically initiate the file transfer based on the file transfer scheduling data.

In some implementations of the computing platform, the processor(s) may execute the instructions to directly transfer the file without downloading the file to local memory.

In some implementations of the computing platform, the processor(s) may execute the instructions to obtain, from a configuration database, file transfer configuration data; and initiate the file transfer based on the file transfer configuration data.

What is claimed is:

1. An apparatus configured for secure file transfer, the apparatus comprising:
a non-transient computer-readable storage medium having executable instructions embodied thereon; and
one or more hardware processors configured to execute the instructions to:
receive, via a microservice, a file transfer request to transfer a file from an on-premises server to cloud data storage;
authenticate the microservice with the on-premises server using an external vault-stored authentication key which is stored independent of the on-premises server and the cloud data storage; and
initiate the file transfer after authentication with the on-premises server.

2. The apparatus of claim 1 wherein the one or more hardware processors are further configured to execute the instructions to:
authenticate the microservice with the on-premises server using the external vault-stored authentication key stored in a key vault and independent of the microservice.

3. The apparatus of claim 1 wherein the one or more hardware processors are further configured to execute the instructions to:
authenticate the microservice with the on-premises server using the external vault-stored authentication key stored in a vault in a database and using key management data stored in a system performing the authenticating.

4. The apparatus of claim 1 wherein the one or more hardware processors are further configured to execute the instructions to:
authenticate the microservice with the on-premises server using the external vault-stored authentication key stored in a vault in a database and using transfer destination data stored in a system performing the authenticating.

5. The apparatus of claim 1 wherein the one or more hardware processors are further configured to execute the instructions to:
update an authentication key in a configuration database without code modification in a system performing the authenticating.

6. The apparatus of claim 1 wherein the one or more hardware processors are further configured to execute the instructions to:
provide a user interface to enable authentication key reconfiguration in a database.

7. The apparatus of claim 1 wherein the one or more hardware processors are further configured to execute the instructions to:
obtain, from a scheduler, file transfer scheduling data; and
automatically initiate the file transfer based on the file transfer scheduling data.

8. The apparatus of claim 1 wherein the one or more hardware processors are further configured to execute the instructions to:
directly transfer the file without downloading the file to local memory.

9. The apparatus of claim 1 wherein the one or more hardware processors are further configured to execute the instructions to:
obtain, from a configuration database, file transfer configuration data; and
initiate the file transfer based on the file transfer configuration data.

10. A processor-implemented method of secure file transfer comprising:
receiving, via a microservice, a file transfer request to transfer a file from an on-premises server to cloud data storage;
authenticating the microservice with the on-premises server using an external vault-stored authentication key stored in a key vault and independent of the on-premises server and the cloud data storage; and
initiating the file transfer after authentication with the on-premises server.

11. The method of claim 10 further comprising:
authenticating the microservice with the on-premises server using the external vault-stored authentication key stored in the key vault and independent of the microservice.

12. The method of claim 10 further comprising:
authenticating the microservice with the on-premises server using the external vault-stored authentication key stored in a database and using key management data stored in a system performing the authenticating.

13. The method of claim 10 further comprising:
authenticating the microservice with the on-premises server using the external vault-stored authentication key stored in a database and using transfer destination data stored in a system performing the authenticating.

14. The method of claim 10 further comprising:
updating an authentication key in a configuration database without code modification in a system performing the authenticating.

15. The method of claim 10 further comprising:
providing a user interface to enable authentication key reconfiguration in a database.

16. The method of claim 10 further comprising:
obtaining, from a scheduler, file transfer scheduling data; and
automatically initiating the file transfer based on the file transfer scheduling data.

17. The method of claim 10 further comprising:
directly transferring the file without downloading the file to local memory.

18. The method of claim 10 further comprising:
obtaining, from a configuration database, file transfer configuration data; and
initiating the file transfer based on the file transfer configuration data.

19. A non-transient computer-readable storage medium having instructions embodied thereon, the instructions being executable by one or more processors to perform a method of secure file transfer, comprising:
receiving, via a microservice, a file transfer request to transfer a file from an on-premises server to cloud data storage;
authenticating the microservice with the on-premises server using an external vault-stored authentication key stored in a key vault and independent of the on-premises server and the cloud data storage; and
initiating the file transfer after authentication with the on-premises server.

20. The non-transient computer-readable storage medium of claim 19 wherein the method further comprises:
authenticating the microservice with the on-premises server using the external vault-stored authentication key stored in the key vault and independent of the microservice.
